(19) United States
(12) Patent Application Publication
(10) Pub. No.: US 2011/0153283 A1
(43) Pub. Date: Jun. 23, 2011

(54) METHOD FOR DESIGNING LAYOUT OF OPTICAL WAVEGUIDES

(75) Inventors: Sayuri Kohara, Kanagawa (JP); Hidetoshi Numata, Kanagawa (JP)

(73) Assignee: International Business Machines Corporation, Armonk, NY (US)

(21) Appl. No.: 12/961,582

(22) Filed: Dec. 7, 2010

(30) Foreign Application Priority Data
Dec. 22, 2009 (JP) 2009-290598

(51) Int. Cl. G06F 17/50

(52) U.S. Cl. 703/1

(57) ABSTRACT

A method and apparatus to optimally design the layout of a plurality of optical waveguides in a case where one or more crossings occur due to a planar configuration of optical waveguides. Embodiments include a plurality of default routes are set for all of a plurality of waveguides so that each of a plurality of waveguides bundled at an input end is split into two or more waveguides, one split waveguide, together with another split waveguide, forms one or more crossings, and a plurality of split waveguides are bundled at least two separate places at an output end. The number of crossings existing on each of the routes is counted. The default value (splitting ratio) of the cross section (thickness and shape) of each of one waveguide and a plurality of waveguides split from the one waveguide is set on the basis of the counted number of crossings.

### FIELD OF THE INVENTION

The present invention relates to methods for designing optical waveguides, and in particular, relates to a method for optimally designing the layout of a plurality of optical waveguides in a case where one or more crossings occur due to a planar configuration of optical waveguides.

### BACKGROUND

Fabrication of a planar optical waveguide circuit from, for example, resin is simple and thus inexpensive. However, when the layout of a plurality of optical waveguides is designed, one or more crossings may occur between the plurality of optical waveguides. An optical power loss becomes large due to crossing and splitting. In a waveguide on which many crossings occur, losses accumulate, and thus signals may be unidentifiable.

In particular, in a multichannel splitting-multiplexing optical waveguide, since the number of crossings varies with each channel, differences in optical power occur among channels.

Japanese Unexamined Patent Application Publication No. 2003-195077 describes an optical waveguide circuit including many crossings but incurring a low loss. However, the optical waveguide circuit is not one that is designed assuming that an optical waveguide positively crosses another optical waveguide having been split.

Japanese Unexamined Patent Application Publication No. 11-287962 describes the general state of the art regarding a partial technique for forming a tapered area in a crossing.

Japanese Unexamined Patent Application Publication No. 2005-266381 describes the general state of the art regarding a partial technique, a tapered waveguide.

Japanese Unexamined Patent Application Publication No. 7-261041 describes the general state of the art regarding a partial technique for considering a crossing angle in a waveguide-crossing optical splitting element.

In a case where one or more crossings occur due to a planar configuration of optical waveguides, it is required to optimally design the layout of a plurality of optical waveguides.

### SUMMARY

When the layout of a plurality of optical waveguides in which a plurality of optical waveguides are bundled to form an input end and an output end, and light beams can be guided from the input end to at least two places at the output end. A plurality of default routes are set for all of a plurality of waveguides so that each of a plurality of waveguides bundled at the input end are split into two or more waveguides, one split waveguide, together with another split waveguide, forms one or more crossings, and a plurality of split waveguides are bundled at least two separate places at the output end. Regarding the route of one waveguide extending from the input end to the output end, the number of crossings existing on the route is counted. The default value (splitting ratio) of the cross section (thickness and shape) of each of the one waveguide and a plurality of waveguides split from the one waveguide is set on the basis of the counted number of crossings. Light beams (as simulation inputs) are input into the plurality of waveguides bundled at the input end. The respective outputs of a plurality of light beams (as simulation outputs) from a plurality of waveguides bundled at least one place at the output end are measured. It is determined whether the measured outputs of the plurality of light beams are uniform (with a threshold predetermined from the viewpoint of optical loss or optical power being a reference). Finally, when it is determined that the measured outputs of the plurality of light beams are not uniform, setting of the value of the cross section of each of the plurality of split waveguides is corrected (adjusted) (the split waveguide is thickened in the case of a large number of crossings and is thinned in the case of a small number of crossings).

This design may be implemented as the steps of a method which a computer is caused to perform as a simulation.

Moreover, the present invention may be implemented as a computer program for causing a computer to perform the steps of the method as a simulation.

Moreover, the present invention may be implemented as a system for performing designing as a simulation by the use of a computer in which the steps of the method are replaced with means to be carried out using a computer.

### BRIEF DESCRIPTION OF DRAWINGS

FIG. 1 is a diagram showing exemplary optical connections between a CPU and memories using multichannel splitting waveguides to which the present invention is applied.

FIG. 2 is a diagram showing basic components of an optical waveguide.

FIG. 3 is a diagram showing the detailed layout of the plurality of optical waveguides in FIG. 1 (multichannel splitting waveguides in which the splitting ratio is optimized and splitting portions and crossing portions included in the multichannel splitting waveguides).

FIG. 4 is a diagram showing a flowchart showing a method according to the present invention for designing, using a computer, the layout of a plurality of optical waveguides in which a plurality of optical waveguides are bundled to form an input end and an output end, and light beams can be guided from the input end to at least two places at the output end.

FIG. 5 is a diagram showing exemplary setting of cross-section default values in 404 and 406 in a feedback loop operation chart in FIG. 4 for uniformalizing the respective powers of multichannel splitting waveguides including crossing portions.

FIG. 6 is a diagram showing the results of calculating a loss in a waveguide crossing portion according to the BPM method: (upper portion) the distribution of refractive indices in a waveguide crossing portion is shown, and (lower portion) the results of calculating waveguide propagation according to the BPM method are shown by a drawing in which optical signals propagate on the X-Y plane (the Z axis in the drawing indicates optical signal strength) (the results of calculation processes in 408 and 410 in the feedback loop operation chart in FIG. 4).

FIG. 7 is a diagram showing the results of measuring optical signal strength using a 12-channel optical splitting-multiplexing waveguide circuit that is fabricated on an experimental basis changing the waveguide splitting ratio so as to uniformalize the power (the results of measuring the optical power of a prototype corresponding to processes in 408 and 410 in the feedback loop operation chart in FIG. 4).

FIG. 8 is a diagram showing exemplary setting of cross-section default values in 404 and 406 in the feedback loop operation chart in FIG. 4 for uniformalizing the powers of a 12-channel optical splitting-multiplexing waveguide circuit including crossing portions.

FIG. 9 is a diagram showing the results of measuring optical signal strength using split optical waveguides that are fabricated on an experimental basis changing the waveguide splitting ratio so as to uniformalize the power (the results of preliminary measurement for checking, in advance, whether the present invention is feasible).

FIG. 10 is a diagram showing the results of calculating, according to the BPM method, optical power output ratios in a case where the ratio between the respective core areas of split optical waveguides is changed.

FIG. 11 is a diagram showing an example for solving a problem in a waveguide output portion, a coupling loss, by reducing the coupling loss.

### DETAILED DESCRIPTION

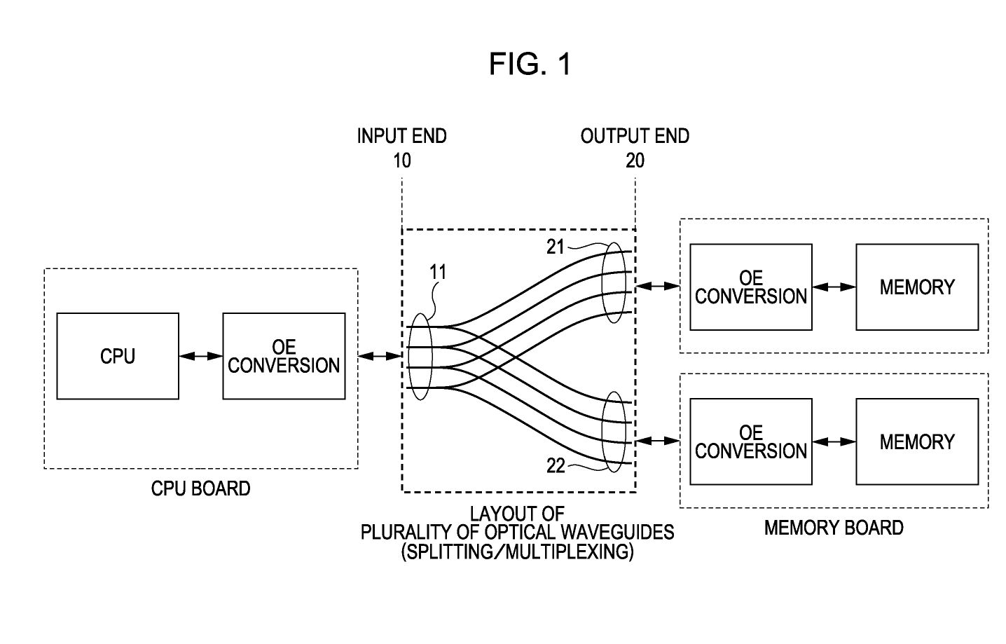

FIG. 1 is a diagram showing exemplary optical connections between a CPU and memories using multichannel splitting waveguides to which the present invention is applied.

In optically attached memories, multichannel signals are split from a CPU and transmitted to a plurality of memories. In this case, for connecting the signals to the memories, in each of the memories, the channels need to be arranged to be bundled in an orderly manner. Typically, the plurality of memories exist as objects to be connected to a memory board (surrounded by dotted lines), and optical waveguides that are arranged to be bundled in an orderly manner are connected to the memories via connectors provided in the memory board (surrounded by dotted lines) so as to form a circuit between the CPU and the memories, optic-electronic (OE) conversion being performed in the circuit.

When individual channels are implemented via a plurality of connections assigned to optical waveguides, a plurality of optical waveguides are bundled to form an input end 10 and an output end 20, and the optical waveguides are split, so that light beams are guided from the input end 10 to at least two places (in this case, two places 21 and 22) at the output end 20.

In the example in the drawing, the number of crossings is large at an end of each memory close to the center of an array of a center memory, and the number of crossings decreases toward the outside from the end. The number of crossings is small at ends of a waveguide array, and the number of crossings increases toward the center of the waveguide array.

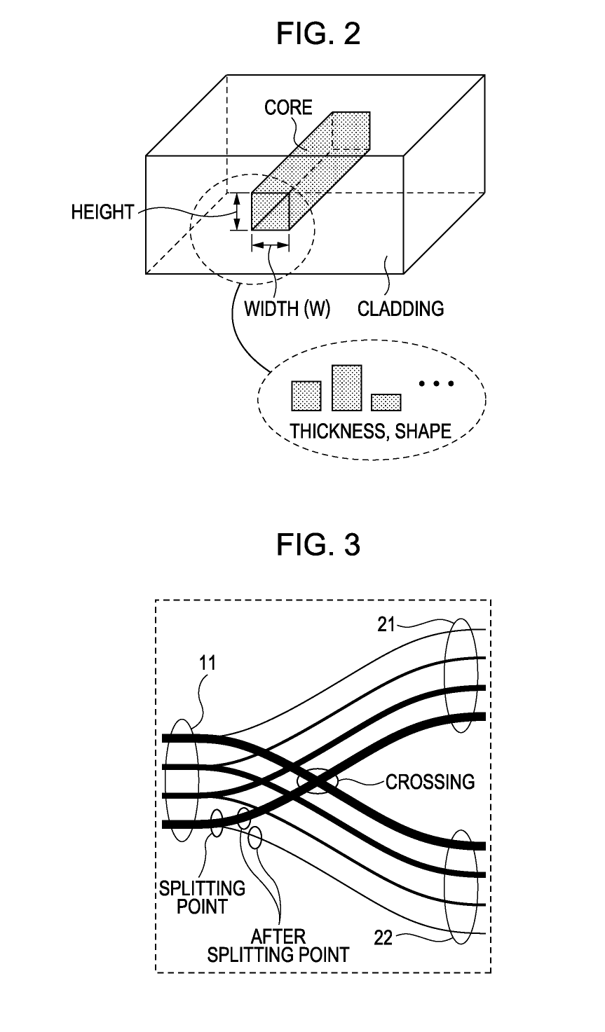

FIG. 2 is a diagram showing basic components of an optical waveguide. An optical waveguide includes a core through which light propagates and a cladding surrounding the core and having a low refractive index. A cladding and a core may be formed on a substrate. Typically, a cladding and a core are formed of, for example, resin. However, the material is not limited to this material.

FIG. 3 is a diagram showing the layout of the plurality of optical waveguides in FIG. 1 in more detail.

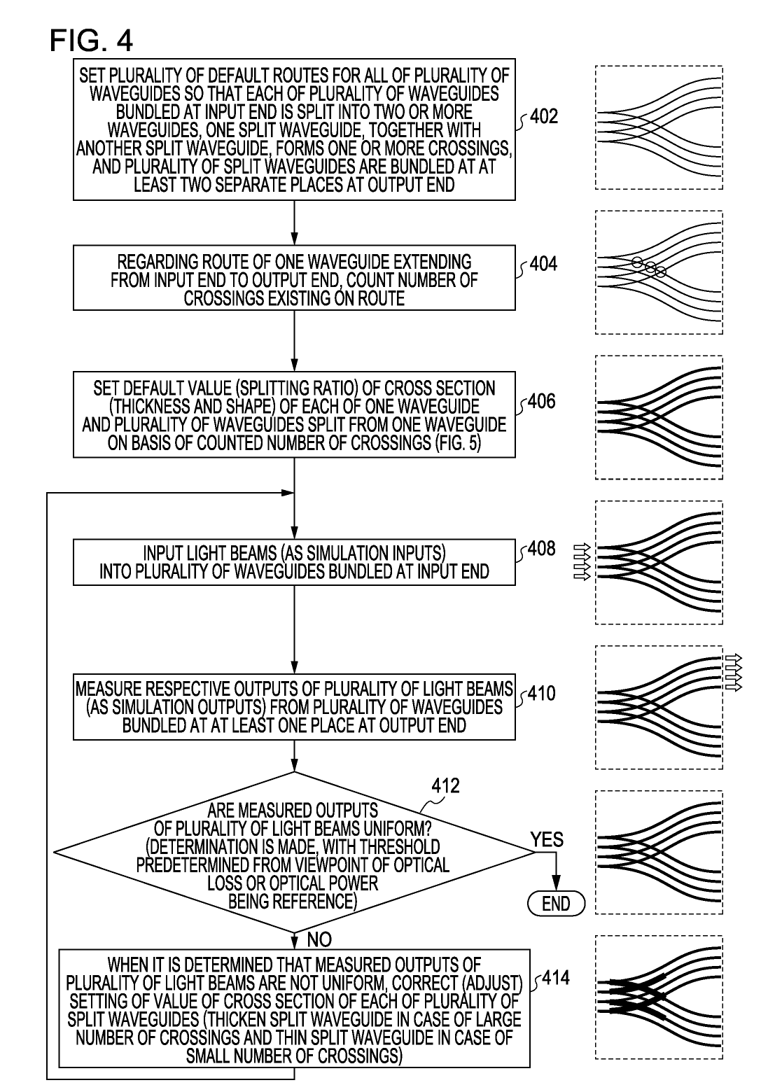

FIG. 4 is a flowchart showing a method according to the present invention for designing, using a computer, the layout of a plurality of optical waveguides in which a plurality of optical waveguides are bundled to form an input end and an output end, light beams can be guided from the input end to at least two places at the output end, and the variance in optical power at the output end is small.

A plurality of default routes are set for all of a plurality of waveguides so that each of a plurality of waveguides bundled at an input end is split into two or more waveguides, one split waveguide, together with another split waveguide, forms one or more crossings, and a plurality of split waveguides are bundled at least two separate places at an output end, as shown in 402.

Then, the number of crossings existing on the route of one waveguide is counted, as shown in 404.

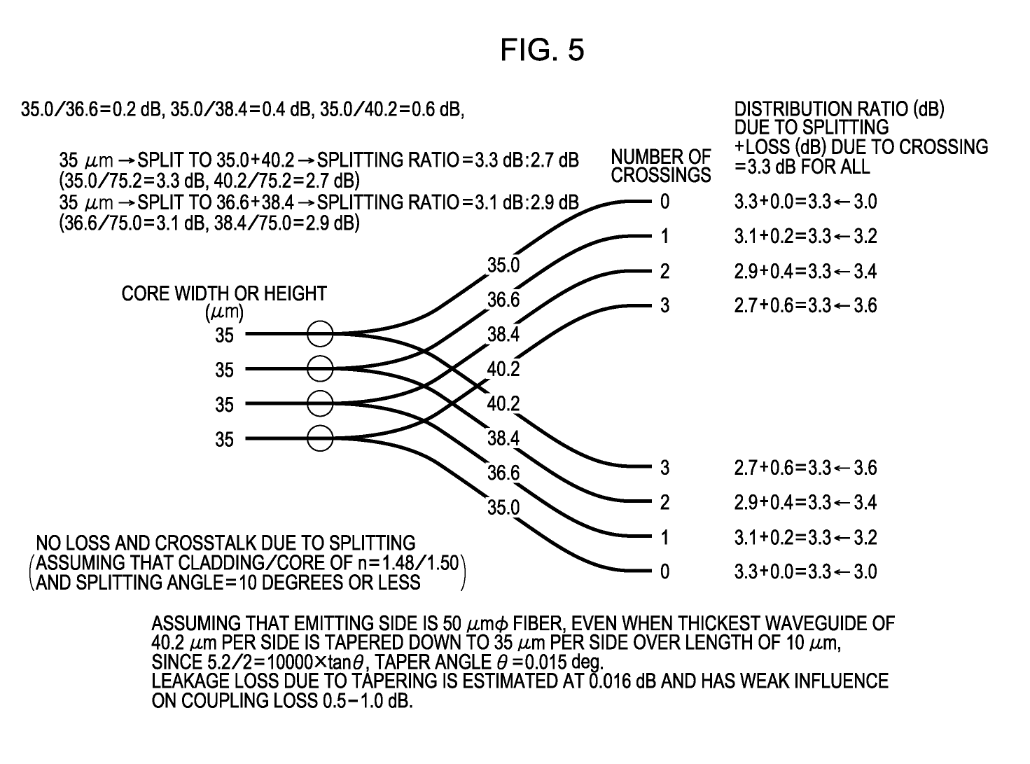

Then, the default value (splitting ratio) of the cross section (thickness and shape) of each of the one waveguide and a plurality of waveguides split from the one waveguide is set on the basis of the counted number of crossings, as shown in 406. FIG. 5 shows exemplary setting of cross-section default values.

Then, light beams (as simulation inputs) are input into the plurality of waveguides bundled at the input end, as shown in 408.

Then, the respective outputs of a plurality of light beams (as simulation outputs) from a plurality of waveguides bundled at least one place at the output end are measured, as shown in 410.

The simulation method is as follows.

Regarding a route i of one waveguide extending from the input end to the output end, an optical power loss L_{c}, due to crossing is calculated according to an optical waveguide simulation method such as the Beam Propagation Method.

Then, a total sum Lᵢ of a splitting ratio (a loss due to splitting) Lₛᵢ, the optical power loss L_{ci} due to crossing, and a coupling loss L_{coupl}, is obtained according to equation 1:

[E1]

Lᵢ=Lₛᵢ+L_{ci}+L_{coupl} (1)

The average of the optical power losses is obtained from the total loss L, of each waveguide obtained in equation 1 according to equation 2:

$$\begin{matrix}[ E 2 ] & \\ {L}_{avg} = \frac{Σ Li}{N} & ( 2 )\end{matrix}$$

After the average L_{avg} of the respective optical power losses of all the waveguides is obtained, in all the waveguides (channels), setting is made so as to satisfy the following relationship:

[E3]

L_{ci}+L_{Si}^{new}+L_{coupl}=L_{avg} (3)

In a multimode waveguide, optical power is split by the ratio between cross sections, the following relationship exists:

[E4]

Lₛᵢ=10 log(Aᵢ)=10 log(wᵢ/wₜₒₜ)=10 log(wᵢ/(wᵢ+w_{b})) (4)

where Aᵢ is the ratio of the area of the waveguide i to the total sum of waveguide areas (a total waveguide width wₜₒₜ=wᵢ+w_{b} when the height is constant, where w_{b} is the width of the other split waveguide) after a splitting point, and wᵢ is the width of the waveguide i.

From equations 3 and 4, the following equations are obtained:

[E5]

Lₛᵢ^{new}=L_{avg}−L_{ci}−L_{coupl} (5)

[E6]

10 log(wᵢ/wₜₒₜ)=Lₛᵢ^{new} (6)

Thus, the width of the waveguide i is corrected from the default value set in 406 in FIG. 4, as shown in equation 7:

[E7]

wi=wₜₒₜ×10^{(L}^{_{Si}}^{^{new}}^{/10}) (7)

Then, it is determined whether the measured outputs of the plurality of light beams are uniform (with a threshold predetermined from the viewpoint of optical loss or optical power being a reference), as shown in 412. Alternatively, the value of loss due to crossing may be adjusted by adjusting the crossing angle (increasing the crossing angle in the case of a large number of crossings and decreasing the crossing angle in the case of a small number of crossings). When it is determined that the measured outputs of the plurality of light beams are uniform, the process is completed.

When a threshold is set as a criterion, for example, the following coefficient of variance:

$$\begin{matrix}[ E 8 ] & \\ CV = \frac{δ}{{L}_{avg}} & ( 8 )\end{matrix}$$

is set as a criterion, and an appropriate threshold is set. In equation 8, δ is a standard deviation:

$$\begin{matrix}[ E 9 ] & \\ δ = \sqrt{{\sum }_{i}^{N} ( {L}_{i} - {L}_{avg} ) / N} & ( 9 )\end{matrix}$$

The processes in 408 and 410 are repeated until CV falls below a predetermined value. When equation 8 for determination is satisfied, the loop is terminated. When equation 8 for determination is not satisfied, a correction process 414 by calculations according to equations 1 to 7 is performed, and the processes in 408 and 410 are repeated.

The reason for repeatedly performing calculation in 408 to 414 is as follows. When the width of a waveguide is changed, since the value of an optical power loss per crossing changes, in a strict sense, it is incorrect to give a fixed value as a crossing loss as shown in the process of setting a default value in 406. Thus, it is necessary to newly obtain a loss per crossing in a new waveguide shape (cross-sectional area) according to a precise optical waveguide simulation such as the Beam Propagation Method and repeat correction until the equation for determination is satisfied.

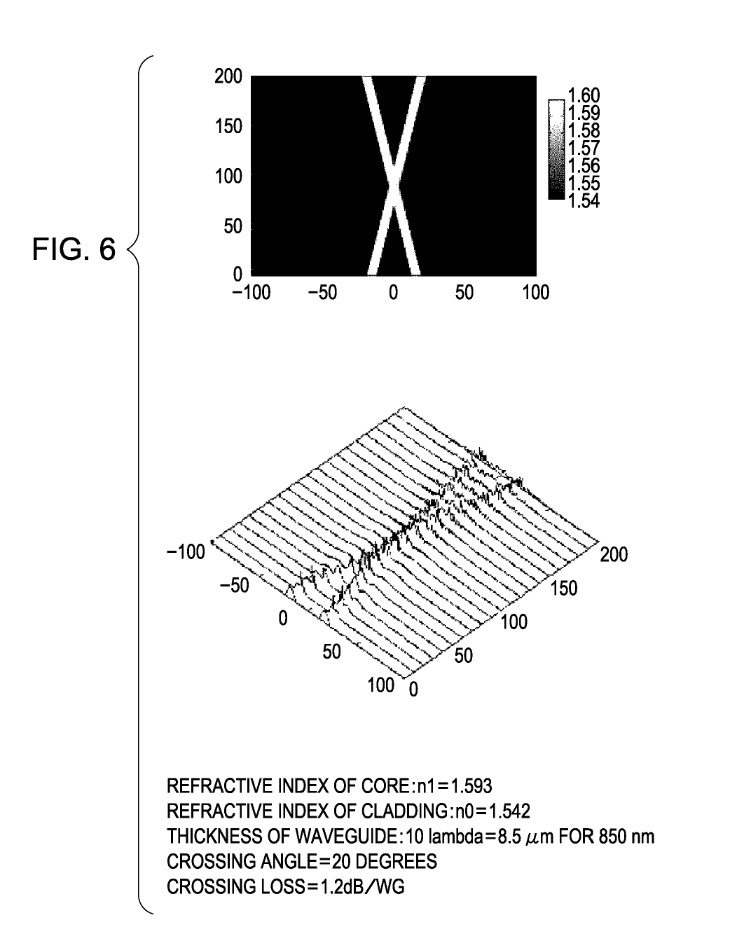

FIG. 6 shows exemplary calculation of a crossing loss according to the Beam Propagation Method. In a case where a refractive index n1 of a core is 1.593, a refractive index n0 of a cladding is 1.542, the thickness of a waveguide is 8.5 μm, the wavelength of light is 850 nm, and the crossing angle is 20 degrees, an optical power loss due to crossing is 1.2 dB.

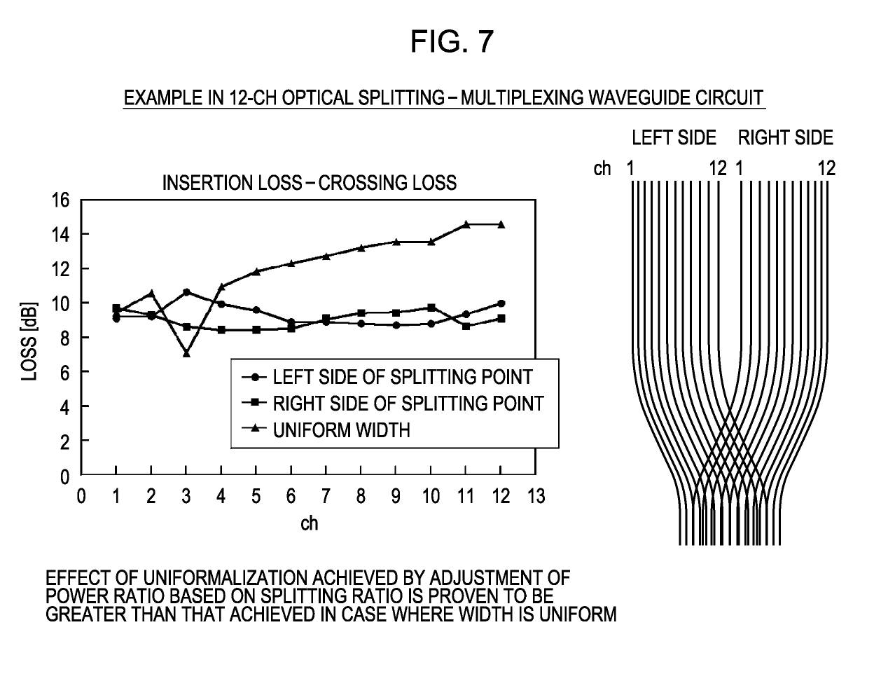

FIG. 7 shows the results of measuring optical signal strength using a 12-channel optical splitting-multiplexing waveguide circuit that is fabricated on an experimental basis changing the waveguide splitting ratio so as to uniformalize the power, i.e., the results of measuring the optical power of the prototype corresponding to the simulation processes in 408 and 410 in a feedback loop operation chart in FIG. 4. In a graph in FIG. 7, the respective actual measured values of optical power losses at an output end in the case of a uniform width and in a case where the shape of each waveguide is corrected according to the method in FIG. 4 are plotted and compared with each other. The values of optical power on the left and right sides of a splitting point in each channel are shown in the drawing. The effect of uniformalization achieved by adjustment of the power ratio based on the splitting ratio is proven to be greater than that achieved in a case where the width is uniform.

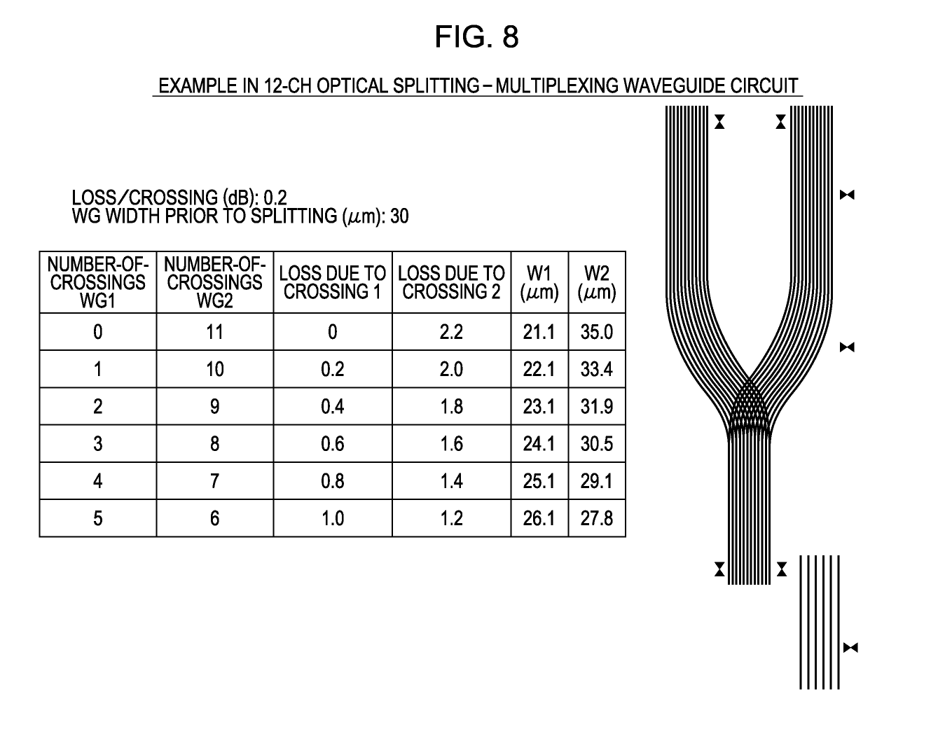

FIG. 8 shows an example in a 12-channel optical splitting-multiplexing waveguide circuit. In a table, the respective widths of a waveguide 1 and a waveguide 2 set according to the method shown in FIG. 4 in a manner that depends on the corresponding numbers of crossings are shown. In this case, the refractive index n1 of the core of each waveguide is 1.593, the refractive index n0 of the cladding is 1.542, the width of the waveguide having not been split is 30 μm, and the thickness of the waveguide is 30 μm.

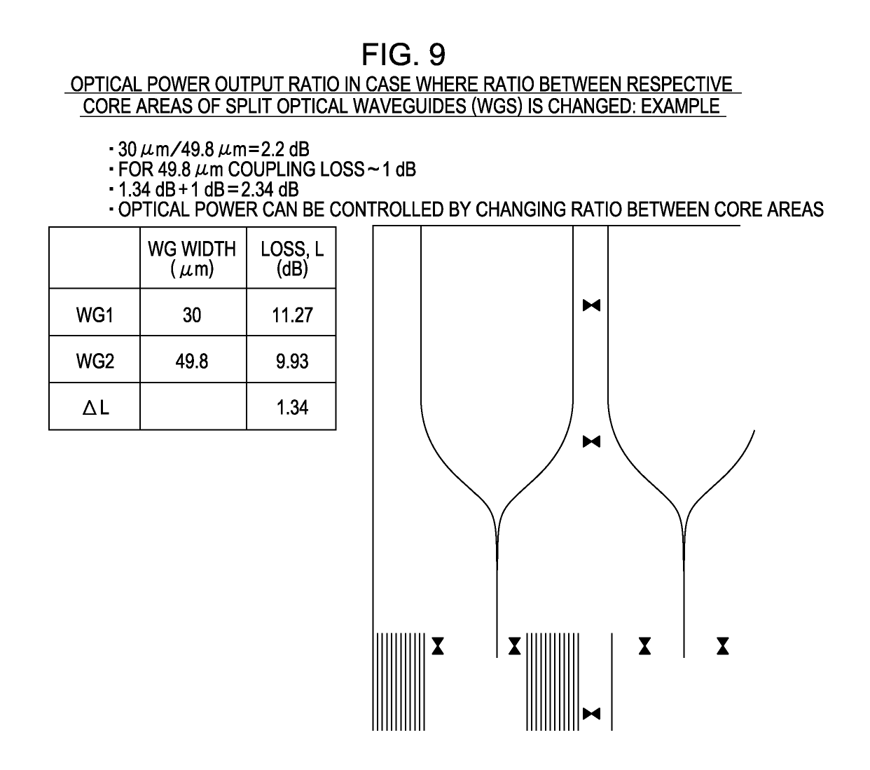

FIG. 9 shows an example of an optical power output ratio in a case where the core splitting ratio between split optical waveguides is changed. In this case, the refractive index n1 of the core of each waveguide is 1.593, the refractive index n0 of the cladding is 1.542, the width of the waveguide having not been split is 30 μM, and the thickness of the waveguide is 30 μm. The respective widths of split waveguides are set to 30 μm (a waveguide 1) and 49.8 μm (a waveguide 2). Assuming that the area ratio is in direct proportion to the optical power output ratio, a predicted difference in the optical power loss is 2.2 dB. In the example, the actual optical power output ratio between the waveguide 1 and the waveguide 2 is 1.34 dB. When it is estimated that the insertion loss for 49.8 μm is about 1 dB (from the ratio between the respective areas of a waveguide and a fiber), this substantially matches the difference in the optical power loss in a case where it is assumed that the area ratio is in direct proportion to the optical power output ratio. Thus, it is verified by experiment that the optical power output ratio can be controlled by the splitting ratio between optical waveguides.

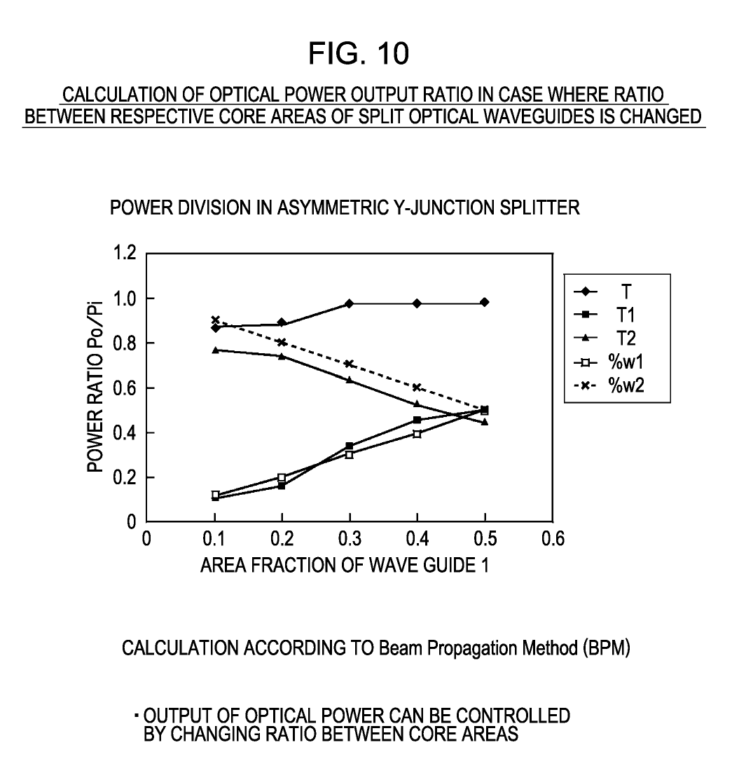

FIG. 10 shows the results of simulating, according to the Beam Propagation Method, optical power output ratios in a case where the core splitting ratio between split optical waveguides is changed. In a graph in the drawing, respective proportions % w1 and % w2 of widths of a waveguide 1 and a waveguide 2 are shown. In the same graph, the result of simulating a total sum T of optical power outputs of the waveguide 1 and the waveguide 2 and respective optical power outputs T1 and T2 of the waveguides corresponding to each splitting ratio are shown. It is verified by the simulation that the optical power output ratio substantially matches the area ratio.

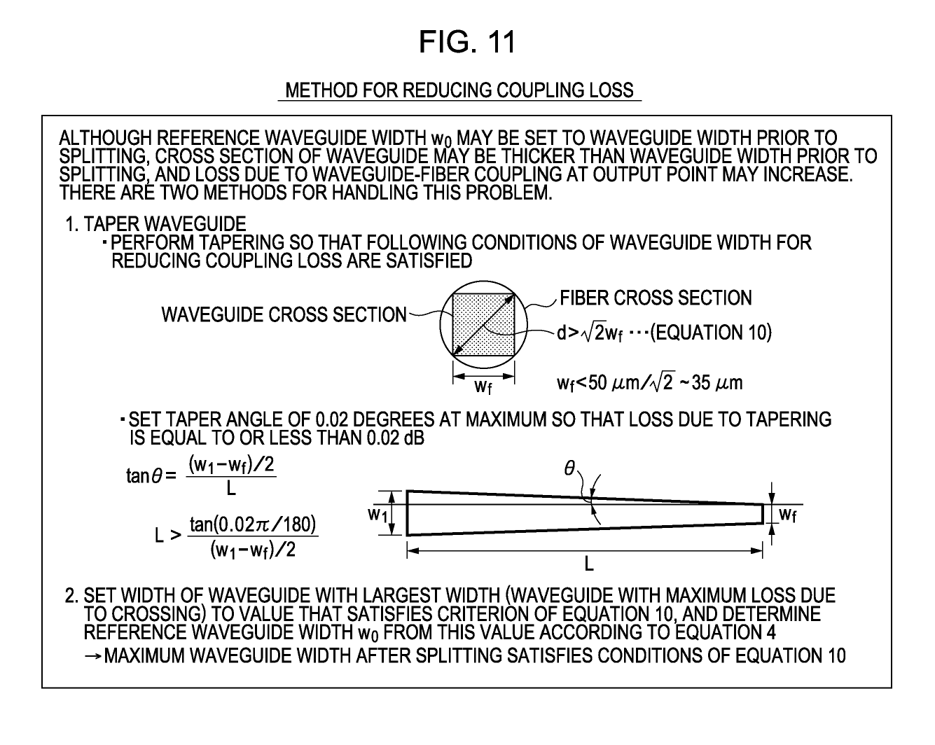

FIG. 11 shows an exemplary method for reducing a coupling loss (L_{coupl} in equation 1) that may occur as a result of adjusting the splitting ratio between waveguides in step 406 in the flowchart in FIG. 4. Two methods for reducing a coupling loss exist. One method is one for reducing a loss due to coupling to a fiber or an optical receiver by reducing the cross-sectional area of an output end by tapering a waveguide. The other method is one for setting the width of a waveguide with the largest width, i.e., a waveguide with the maximum loss due to crossing, to a value that satisfies the criterion of equation 10, and determining a reference waveguide width from the value according to equation 4. The maximum waveguide width after splitting satisfies the conditions of equation 10.

1. A method for designing, using a computer, a layout of a plurality of optical waveguides in which a plurality of optical waveguides are bundled to form an input end and an output end, and light beams can be guided from the input end to at least two places at the output end, the method causing the computer to perform the steps of:
setting a plurality of default routes for all of a plurality of waveguides so that each of a plurality of waveguides bundled at the input end is split into two or more waveguides, one split waveguide, together with another split waveguide, forms one or more crossings, and a plurality of split waveguides are bundled at least two separate places at the output end;
counting, regarding a route of one waveguide extending from the input end to the output end, a number of crossings existing on the route;
setting a default value (splitting ratio) of a cross section (thickness and shape) of each of the one waveguide and a plurality of waveguides split from the one waveguide on the basis of the counted number of crossings;
inputting light beams (as simulation inputs) into the plurality of waveguides bundled at the input end;
measuring respective outputs of a plurality of light beams (as simulation outputs) from a plurality of waveguides bundled at least one place at the output end;
determining whether the measured outputs of the plurality of light beams are uniform (with a threshold predetermined from the viewpoint of optical loss or optical power being a reference); and
correcting (adjusting), when it is determined that the measured outputs of the plurality of light beams are not uniform, setting of the value of the cross section of each of the plurality of split waveguides (thickening the split waveguide in the case of a large number of crossings and thinning the split waveguide in the case of a small number of crossings).

2. The method according to claim 1, further causing the computer to repeatedly perform, after performing the step of correcting (adjusting) the setting of the value of the cross section of the split waveguide (thickening the split waveguide in the case of a large number of crossings and thinning the split waveguide in the case of a small number of crossings), the steps of:
inputting light beams (as simulation inputs) into the plurality of waveguides bundled at the input end;
measuring respective outputs of a plurality of light beams (as simulation outputs) from the plurality of waveguides bundled at the at least one place at the output end; and
determining whether the measured outputs of the plurality of light beams are uniform (with the threshold predetermined from the viewpoint of optical loss or optical power being the reference).

3. A computer program product for causing a computer to design a layout of a plurality of optical waveguides in which a plurality of optical waveguides are bundled to form an input end and an output end, and light beams can be guided from the input end to at least two places at the output end, the computer program product:
setting a plurality of default routes for all of a plurality of waveguides so that each of a plurality of waveguides bundled at the input end is split into two or more waveguides, one split waveguide, together with another split waveguide, forms one or more crossings, and a plurality of split waveguides are bundled at least two separate places at the output end;
counting, regarding a route of one waveguide extending from the input end to the output end, a number of crossings existing on the route;
setting a default value (splitting ratio) of a cross section (thickness and shape) of each of the one waveguide and a plurality of waveguides split from the one waveguide on the basis of the counted number of crossings;
inputting light beams (as simulation inputs) into the plurality of waveguides bundled at the input end;
measuring respective outputs of a plurality of light beams (as simulation outputs) from a plurality of waveguides bundled at least one place at the output end;
determining whether the measured outputs of the plurality of light beams are uniform (with a threshold predetermined from the viewpoint of optical loss or optical power being a reference); and
correcting (adjusting), when it is determined that the measured outputs of the plurality of light beams are not uniform, setting of the value of the cross section of each of the plurality of split waveguides (thickening the split waveguide in the case of a large number of crossings and thinning the split waveguide in the case of a small number of crossings).

4. A system designing, using a computer, a layout of a plurality of optical waveguides in which a plurality of optical waveguides are bundled to form an input end and an output end, and light beams can be guided from the input end to at least two places at the output end, the system comprising:
means for setting a plurality of default routes for all of a plurality of waveguides so that each of a plurality of waveguides bundled at the input end is split into two or more waveguides, one split waveguide, together with another split waveguide, forms one or more crossings, and a plurality of split waveguides are bundled at least two separate places at the output end;
means for counting, regarding a route of one waveguide extending from the input end to the output end, a number of crossings existing on the route;
means for setting a default value (splitting ratio) of a cross section (thickness and shape) of each of the one waveguide and a plurality of waveguides split from the one waveguide on the basis of the counted number of crossings;
means for inputting light beams (as simulation inputs) into the plurality of waveguides bundled at the input end;
means for measuring respective outputs of a plurality of light beams (as simulation outputs) from a plurality of waveguides bundled at least one place at the output end;
means for determining whether the measured outputs of the plurality of light beams are uniform (with a threshold predetermined from the viewpoint of optical loss or optical power being a reference); and
means for correcting (adjusting), when it is determined that the measured outputs of the plurality of light beams are not uniform, setting of the value of the cross section of each of the plurality of split waveguides (thickening the split waveguide in the case of a large number of crossings and thinning the split waveguide in the case of a small number of crossings).
